(19) United States
(12) Patent Application Publication
(10) Pub. No.: US 2002/0086082 A1
(43) Pub. Date: Jul. 4, 2002

(54) Extrusion die for increasing and distributing the uniform velocity profile of foamed plastic melt across the die open area

(75) Inventor: Victor M. Grossi, Woodbridge (CA)

Correspondence Address: Peter K. Sommer, Esq., Phillips, Lytle, Hitchcock, Blaine & Huber LLP, Intellectual Property Group, 3400 HSBC Center, Buffalo, NY, 14203, US

(73) Assignee: CPI Plastics Groups Ltd.

(21) Appl. No.: 09/753,840

(22) Filed: Jan. 3, 2001

(51) Int. Cl. B29C 47/12

(52) U.S. Cl. 425/467

(57) ABSTRACT

The present invention provides a portion of a die assembly (20) for use in the extrusion of foamed polystyrene. The die assembly includes a first plate (21), a second plate (22), and an insert (23). The first plate has an upstream face (24), a downstream face (25), and a first opening (26) extending between the two first plate faces. The walls (28) of this opening are divergent in a downstream direction. The second plate has an upstream face (29) arranged to abut the first plate downstream face, a downstream face (30), and a second opening (31) extending between the second plate faces and communicating with the first opening. The second opening is bounded by non-divergent walls (32). The insert has a forward marginal end portion mounted on the first plate in the first opening, and has a rearward marginal end portion arranged in the second opening. The insert has a leading edge (33) that is spaced substantially equidistantly from the first opening walls in the vicinity of the first plate upstream face by a distance (D), and has a rear edge (34). The rear edge has a transverse cross-section configured and arranged such that a distance between adjacent portions of the rear edge and between the rear edge and the second plate opening walls in the vicinity of the second plate downstream face is no more than a predetermined distance (d). The velocity profile of foamed polystyrene passing sequentially through the first and second plate openings is increased in length or amplitude and distributed substantially uniformly across the transverse cross-sectional area of the second plate opening in the vicinity of the insert rear edge.

### TECHNICAL FIELD

The present invention relates generally to the field of extrusion dies, and, more particularly, to an improved portion of an extrusion die assembly that intensifies and equalizes the velocity profile of a flow of foamed polystyrene plastic material across the transverse cross-sectional area of an opening through the die.

### BACKGROUND ART

It is known to extrude certain plastic materials into various shapes and configurations.

More recently, it has become known to extrude a foamed polystyrene plastic material into shapes used for decking, Venetian blind slats, railings, and the like. These various objects have different transverse cross-sections. A heated plastic material, such as foamed polystyrene, behaves as a viscous fluid. According to conventional bounder layer theory, such a viscous fluid, if extruded through a conduit having a circular transverse cross-section, would have a velocity profile that is somewhat parabolic in shape (see FIG. 4). In other words, the flow velocity would be substantially zero immediately adjacent the walls of the conduit, but would reach a maximum at the nominal centerline of conduit.

In extruding thermoplastic materials, it may be desired to change and equalize the velocity profile so that one portion (e.g., the center) of the extrudate is not treated significantly differently than another portion thereof (e.g., adjacent the conduit walls). In other words, in these applications, it may well be desirable to increase the normal velocity profile by decreasing the open die cross-sectional area, and to distribute it across the transverse cross-sectional area of the opening, whatever its profile or configuration, to increase shearing, to intensify mixing, to raise the temperature, to decrease fluid viscosity and to provide more uniform foaming.

The same overall flow rate through a smaller open cross-sectional area of the second die section increases the fluid velocity profile, intensifies friction and shear, and improves mixing. All of this results in a more uniform velocity profile distributed across the open cross-sectional area of the die opening, which is critical for more uniform foaming of the melt and dimensional and density stability of the extruded profile. The polymer melt is a non-Newtonian fluid. The viscosity of such fluid decreases with increased shearing, and with increased temperature. An increase in the shearing of the fluid also raises its temperature. A higher fluid velocity increases the rate of heat transfer between the fluid and the tooling, and in the volume of the fluid.

### DISCLOSURE OF THE INVENTION

With parenthetical reference to the corresponding parts, portions, or surfaces of the disclosed embodiment, merely for purposes of illustration and not by way of limitation, the present invention provides an improved die assembly for use in the extrusion of a suitable plastic material, such as foamed polystyrene.

The improved die assembly (20) broadly includes a first plate (21) having an upstream face (24), having a downstream face (25), and having a first opening (26) extending between these two first plate faces. The walls (28) surrounding the first opening are divergent in a direction from the first plate upstream face to the first plate downstream face. A second plate (22) has an upstream face (29) arranged to abut the first plate downstream face, has a downstream face (30), and has a second opening (31) extending between the second plate faces and communicating with the first opening. The second opening is bounded by walls (32). An insert (23) has a forward marginal end portion mounted on the first plate in the first opening, and has a rearward marginal end portion arranged in the second opening. The insert has a leading edge (33) that is spaced substantially equidistantly from the first opening walls in the vicinity of the first plate upstream face by a distance (D), and has a rear edge (34). The rear edge having a transverse cross-section configured and arranged such that a distance between adjacent portions of the rear edge and between the rear edge and the second plate opening walls in the vicinity of the second plate downstream face is no more than a predetermined distance (d), such that the velocity profile of foamed polystyrene passing sequentially through the first and second plate openings will be intensified, and distributed substantially uniformly across the transverse cross-sectional area of the second plate opening in the vicinity of the insert rear edge.

In the preferred embodiment, the insert leading edge is substantially coplanar with the first plate upstream face, and the insert rear edge is substantially coplanar with the second plate downstream face. The predetermined distance (d) in the case of foamed polystyrene may be on the order of about 0.150 inches.

Accordingly, the general object of the invention is to provide an improved die assembly for use in connection with the extrusion of certain plastic materials.

Another object is to provide an improved die assembly for use in the extrusion of foamed polystyrene.

Still another object is to provide an improved die assembly for use in the extrusion of various materials, in which the common fluid velocity profile across the transverse cross-sectional area of the opening through which the extruded material must pass, is intensified and distributed more uniformly across such transverse cross-sectional area such that the properties of the extruded material will be more alike across the cross-sectional area.

These and another objects and advantages will become apparent from the foregoing and ongoing written specification, the drawings, and the appended claims.

### BRIEF DESCRIPTION OF THE DRAWINGS

FIG. 1 is a fragmentary view of the improved die assembly, this view showing the first and second plates in section (but without cross-hatching), and showing the insert interposed therebetween in elevation.

FIG. 2 is a fragmentary transverse vertical sectional view thereof, taken generally on line 2-2 of FIG. 1.

FIG. 3 is a fragmentary transverse vertical sectional view thereof, taken generally on line 3-3 of FIG. 1, and shows the downstream end of the insert.

FIG. 4 is an illustrative schematic comparing the representative velocity profile of the improved die assembly with that of a similar die assembly if the insert had not been present for the same cross-sectional area of the die opening.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

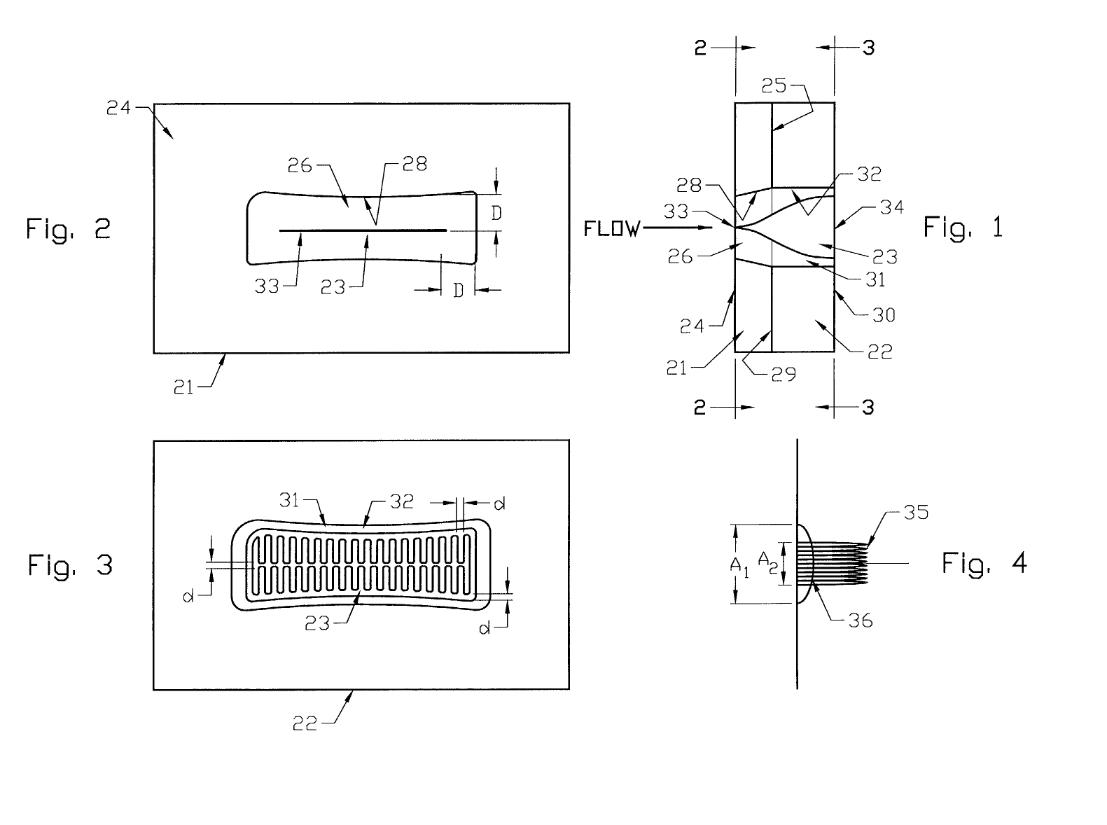

Turning now to the drawings, and, more particularly, to FIG. 1 thereof, the present invention broadly provides an improved portion of a die assembly, generally indicated at 20, for use in the extrusion of a plastic material, such as foamed polystyrene. The improved die assembly broadly includes a first plate 21, a second plate 22 and an insert 23.

The first plate 21 is shown as being a rectangular plate-like member having a rectangular vertical upstream face 24; a planar rectangular vertical downstream face 25; and a first opening, generally indicated at 26, extending between the first plate faces 24, 25. This opening is bounded by walls 28, which are shown as being divergent in a downstream direction from the first plate upstream face 24 to the first plate downstream face 25.

The second plate 22 is shown as having an planar rectangular vertical upstream face 29, and a planar rectangular vertical downstream face 30. The second plate has a through opening 31. The second opening is bounded by walls 32 which do not diverge in the downstream direction.

Turning now to FIGS. 1 and 3, the insert 23 is depicted as having a forward marginal end portion mounted on the first plate in the first opening, and having a rearward marginal end portion arranged in the second opening. The insert leading edge 33 is spaced substantially equidistantly from the first opening walls in the vicinity of the first plate upstream face by a distance D. The rear edge 34 has a transverse cross-section that is configured and arranged such that the distance between adjacent portions of the rear edge and between the rear edge and the second plate opening walls in the vicinity of the second plate downstream face is no more than a predetermined distance d.

In the preferred embodiment, the insert leading edge (33) is substantially coplanar with the first plate upstream face (24), and the insert rear edge (34) is substantially coplanar with the second plate downstream face (30). When used in connection with the extrusion of foamed polystyrene, the predetermined distance d may be on the order of about 0.150 inches. As best shown in FIG. 3, the rear edge has somewhat of an undulating appearance, with the various undulations subdividing the profile of the second plate opening into smaller areas. As shown in FIG. 4, the velocity profile 35 of foamed polystyrene passing sequentially through the first and second plate openings is radically increased and distributed substantially uniformly across the entire transverse cross-sectional area of the second plate opening in the vicinity of the insert rear edge, as compared with the velocity profile 36 that would obtain if the insert were not present. In other words, if A₁ represents the open area in the die assembly without the insert at the downstream face, and A₂ represents the open area in the die assembly with the insert at the downstream face, then it can be seen that A₁ is much greater than A₂ (i.e.,A₁>>A₂).

Modifications

The present invention expressly contemplates that many changes and modifications may be made. For example, the two plates that constitute the die assembly may be used as part or portions of other structure, such as a larger extrusion die assembly. The transverse profile of the openings through the first and second plates may readily be changed as desired. Hence, the leading and trailing edges of the insert will have to be changed to accommodate the particulate shape of the profile being used. The die assembly is preferably made from steel. The die may be heated to substantially the same temperature as the extruded material, or may be cooled, as desired. Heating or cooling may be used to modify the characteristics of the surface skin of the extruded material.

Accordingly, while the presently-preferred form of the improved die has been shown and described, and several modifications thereof discussed, persons skilled in this art will readily appreciate that various additional changes and modifications may be made without departing from the spirit of the invention, as defined and differentiated in the following claims.

What is claimed is:

1. A die assembly for use in the extrusion of foamed polystyrene, comprising:
a first plate having an upstream face, having a downstream face, and having a first opening extending between said first plate faces, the walls surrounding said first opening being divergent in a direction from said first pate upstream face to said first plate downstream face;
a second plate having an upstream face arranged to abut said first plate downstream face, having a downstream face, and having a second opening extending between said second plate faces and communicating with said first opening, said second opening being bounded by walls; and
an insert having a forward marginal end portion mounted on said first plate in said first opening and having a rearward marginal end portion arranged in said second opening, said insert having a leading edge that is spaced substantially equidistantly from said first opening walls in the vicinity of said first plate upstream face, and having a rear edge, said rear edge having a transverse cross-section configured and arranged such a distance between adjacent portions of said rear edge and between said rear edge and said second plate opening walls in the vicinity of said second plate downstream face is no more than a predetermined distance;
such that the velocity profile of foamed polystyrene passing sequentially through said first and second plate openings will be increased and distributed substantially uniformly across the transverse cross-sectional area of said second plate opening in the vicinity of said insert rear edge.

2. A die assembly as set forth in claim 1 wherein said insert leading edge is substantially coplanar with said first plate upstream face.

3. A die assembly as set forth in claim 1 wherein said insert rear edge is substantially coplanar with said second plate downstream face.

4. A die assembly as set forth in claim 1 wherein said predetermined distance is about 0.150 inches.
